(19) United States
(12) Patent Application Publication
(10) Pub. No.: US 2013/0137393 A1
(43) Pub. Date: May 30, 2013

(54) AUTO SELECTION OF MOBILE COMMUNICATION TRANSPORT MODE

(71) Applicants: Denis L. Sverdlov, Sankt-Peterburg (RU); Sergey Mikhaylov, Velikiy Novgorod (RU)

(72) Inventors: Denis L. Sverdlov, Sankt-Peterburg (RU); Sergey Mikhaylov, Velikiy Novgorod (RU)

(73) Assignee: RAWLLIN INTERNATIONAL INC.

(21) Appl. No.: 13/306,612

(22) Filed: Nov. 29, 2011

(51) Int. Cl. H04W 8/22; H04W 4/26

(52) U.S. Cl. 455/406; 455/418

(57) ABSTRACT

Providing for a point-to-point analysis of available transport modes for a mobile device and a target device is described herein. By way of example, the point-to-point analysis can be performed to determine available transport modes for a mobile communication. A target device can be selected on a user interface of the mobile device, for example, by user input selection in a contact registry. In at least one aspect, a result of the point-to-point analysis can indicate presence of the target device on a network, and availability to receive a call or a message from the mobile device. Optionally, charging rates for the mobile device or target device can be displayed on the user interface. In some aspects, a transport mode selection made at the user interface of the mobile device can override an automated selection, providing user control over conventionally background-only services of mobile communications.

### TECHNICAL FIELD

The present application is generally related to mobile communications, and more particularly to providing automated selection of a mobile transport mode for communication(s) related to a mobile communication device.

### BACKGROUND

Mobile communications is a rapidly evolving industry fueled by a high degree of consumer demand and facilitated by sophisticated organizations skilled in researching, developing and deploying a wide range of advancements in wireless communication technology. One metric against which development in wireless communication technology is measured is fixed electronic communications. Fixed electronic communications include data transport mechanisms having a wired data interface to an end customer or consumer. Examples of fixed electronic communications can include coaxial cable Internet services, digital subscriber line Internet services, optical fiber Internet services, or the like. Conventionally, fixed electronic communication transport mechanisms have provided higher data rate capabilities to end consumers. Data rate is considered an important metric, because popular applications such as downloading data (e.g., files), viewing streaming television, streaming radio, and even some voice over Internet Protocol applications require relatively high data rates. However, with recent advances in wireless communication technology, this conventional rule of thumb is being challenged, and in many cases mobile communications such as cellular networks can provide comparable or higher data rates than fixed electronic communication networks.

As mobile communication technologies deploy advanced technology infrastructure, these newer networks often co-exist with legacy network infrastructure in or near a given geographic region. Thus, user equipment configured for multiple types of communication networks often have a choice as to which network to connect for mobile communication services. As one example, some mobile service providers maintain third generation packet-switched UMTS (universal mobile telecommunications system) networks alongside circuit-switched GSM (global system for mobile communication) networks. Thus, a mobile device capable of communicating on the UMTS network or the GSM network might select one network or the other for communication, in a geographic region where both networks are available. Often, a service provider policy will dictate one network as a default when two or more networks are available, but in other cases a service provider policy will allow a mobile device to automatically connect to whichever network provides the best signal, for instance.

Additionally, mobile communication service providers often have agreements with other providers to facilitate mobile communications between subscribers served by different service providers. These agreements are generally motivated by the desire to make mobile calling available to all other mobile phone subscribers, as well as to landline phones, and because end users having a choice among a service providers tend, in the aggregate, to choose the services of a range of providers. Accordingly, one mobile call might be routed from a service provider's radio access network to the public switched telephone network to facilitate a mobile to landline call, whereas another mobile call might be routed from one service provider's radio access network to another service provider's radio access network to facilitate a mobile to mobile call. Moreover, because the respective radio access networks can be of differing technologies, variations in data rates, quality of service and even in available communication services of those radio access networks can affect service for a mobile to mobile call. Thus, although a service provider may introduce new services along with new infrastructure deployments, the availability of those services can depend on other factors not entirely within the service provider's control.

The above-described deficiencies of today's mobile communications systems are merely intended to provide an overview of some of the problems of conventional systems, and are not intended to be exhaustive. Other problems with the state of the art and corresponding benefits of one or more of the various non-limiting embodiments may become further apparent upon review of the following detailed description.

### SUMMARY

The following description and the annexed drawings set forth in detail certain illustrative aspects of the disclosed subject matter. These aspects are indicative, however, of but a few of the various ways in which the principles of the various embodiments may be employed. The disclosed subject matter is intended to include all such aspects and their equivalents. Other advantages and distinctive features of the disclosed subject matter will become apparent from the following detailed description of the various embodiments when considered in conjunction with the drawings.

Described herein are systems, methods and articles of manufacture that facilitate automatic selection of transport mode for mobile communications. The systems, methods and articles of manufacture described herein can be implemented in connection with any suitable communication device connected to a platform for wireless communication. Examples of such a communication device can include a mobile handset operating in wireless communication network, a computer, a handheld device, a smartphone, or the like.

In one or more disclosed embodiments, a point-to-point analysis of available transport modes for a mobile device and a target device can be performed to determine available transport modes for a mobile communication. A target device can be selected on a user interface of the mobile device, for example, by user input selection in a contact registry. In at least one aspect, a result of the point-to-point analysis can indicate presence of the target device on a network, and availability to receive a call or a message from the mobile device.

According to further aspects, a point-to-point analysis can derive characteristics of respective communication links of the mobile device and target device in determining available transport modes for connecting a mobile device and a target device. These characteristics can be referenced against constraints associated with a particular type of call or communication service, in some aspects of the subject disclosure, and a result of the analysis and corresponding availability of the call or communication service can be displayed on the mobile device prior to initiation of the call or communication service. This can provide a prior indication of likelihood of success of the call or communication service. Also a recommended transport mode, such as short message service or multimedia messaging service, can be output at the user interface, based at least in part on the point-to-point analysis.

According to some aspects, a list of potential transport modes for connecting a mobile device and a target device can be acquired and output to a user interface of the mobile device. A user can then select a transport mode for a call or communication service, where available, with some advance indication of success of the call or communication service. Moreover, quality, data rate and other characteristics of respective transport modes can also be output at the user interface, to indicate capabilities or limitations of respective transport modes. In particular aspects, a billing rate associated with respective transport modes for the mobile device or for the target device can be output to the user interface, to give a user an indication of cost associated with a particular call with the target device when utilizing a particular transport mode.

In still other aspects, an override selection can be output to a user interface of a mobile device, facilitating user override of a default or recommended transport mode for a call. A user input selection can be received identifying a transport mode, or a type of service. If the user input selection does not match a default or algorithm-recommended transport mode or type of service, the default can be overridden and a call or type of service in accordance with the user input implemented instead. This facilitates user control, for instance, over network transport modes, types of messaging service, and the like, based on point-to-point knowledge of link conditions between the mobile device and target device, as one example.

In a particular aspect of the subject disclosure, provided is a system facilitating mobile communications. The system can comprise a query component configured to request a characteristic of a mobile communication link from a network serving a first mobile communication device, and to request from the network a feature of a target communication device. Additionally, the system can comprise a device compliance component configured to compare the feature of the target communication device with a corresponding feature of the first mobile communication device and determine compatibility of the first mobile communication device and the target communication device with one of a set of communication transport modes, and a link compliance component configured to compare the characteristic of the mobile communication link with a predefined link preference of the one of the set of communication transport modes. Further to the above, the system can comprise a transport component configured to select the one of the set of communication transport modes for a call between the first mobile communication device and the target communication device in response to the determined compatibility satisfying a condition defined by a compatibility function, and in response to the characteristic satisfying a second condition defined by a link preference function.

In another aspect, provided is a method of mobile communication. The method can comprise referencing stored characteristics of a first device pertaining to compatibility with a type of mobile communication call and receiving a selection of a target device for the mobile communication call. Moreover, the method can also comprise referencing stored characteristics of the target device pertaining to compatibility with the type of mobile communication call and outputting the type of mobile communication call as available at least in response to the stored characteristics of the first device and stored characteristics of the target device satisfying a condition of the type of mobile communication call.

According to an additional aspect, described is a user interface module for a mobile device. The user interface module can comprise a visual component configured for outputting visual information to a graphical display of a user interface of the mobile device. In addition, the user interface module can comprise a transport management component configured for outputting to the user interface a set of network connections currently available to communicatively connect the mobile device with a target device, the user interface configured to receive input information at the user interface selecting one of the set of network connections, the transport management component further configured to initiate a call between the mobile device and the target device via the selected one of the set of network connections.

The following description and the annexed drawings set forth in detail certain illustrative aspects of the disclosed subject matter. These aspects are indicative, however, of but a few of the various ways in which the principles of the innovation can be employed and the disclosed subject matter is intended to include all such aspects and their equivalents. Other advantages and novel features of the disclosed subject matter will become apparent from the following detailed description of the innovation when considered in conjunction with the drawings.

### BRIEF DESCRIPTION OF THE DRAWINGS

FIG. 1 depicts a block diagram of an example system that provides automatic transport selection for mobile communications in aspects disclosed herein.

FIG. 2 illustrates a block diagram of a sample network diagram facilitating provision of a point-to-point analysis for the automatic transport selection.

FIG. 3 depicts a block diagram of example originating and target device capabilities for point-to-point device analysis for mobile communication.

FIG. 4 illustrates a block diagram of a sample user interface providing point-to-point analysis of intervening communication links for such communication.

FIG. 5 depicts a block diagram of an example system that provides user override of default mobile communication selections according to one aspect(s).

FIG. 6 illustrates a block diagram of an example user interface facilitating user override of default mobile transport modes according to other aspects.

FIG. 7 depicts a flowchart of a sample method for providing automated transport mode selection for mobile communications according to one or more aspects.

FIGS. 8 and 9 depict a flowchart of a sample method for providing point-to-point analysis of a mobile communication for an originating and target device.

FIG. 10 illustrates a block diagram of an example mobile handset that can be configured for operation in conjunction with one or more disclosed aspects.

FIG. 11 depicts a block diagram of a sample wireless communication network that can be operable for facilitating one or more disclosed aspects.

FIG. 12 depicts a block diagram of a sample electronic computer device that can be implemented in conjunction with still other disclosed aspects.

### DETAILED DESCRIPTION

The disclosed subject matter is described with reference to the drawings, wherein like reference numerals are used to refer to like elements throughout the description. In the following description, for purposes of explanation, numerous specific details are set forth in order to provide a thorough understanding of the subject innovation. It may be evident, however, that the disclosed subject matter may be practiced without these specific details. In other instances, well-known structures and devices are shown in block diagram or schematic form in order to facilitate describing the subject innovation.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “module”, “interface,” “user interface”, and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)), a smart card, a flash memory device (e.g., card, stick, key drive), and/or a virtual device that emulates a storage device and/or any of the above computer-readable media.

The word “exemplary” where used herein means serving as an example, instance, or illustration. For the avoidance of doubt, the subject matter disclosed herein is not limited by such examples. In addition, any aspect or design described herein as “exemplary”, “demonstrative”, or the like, is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

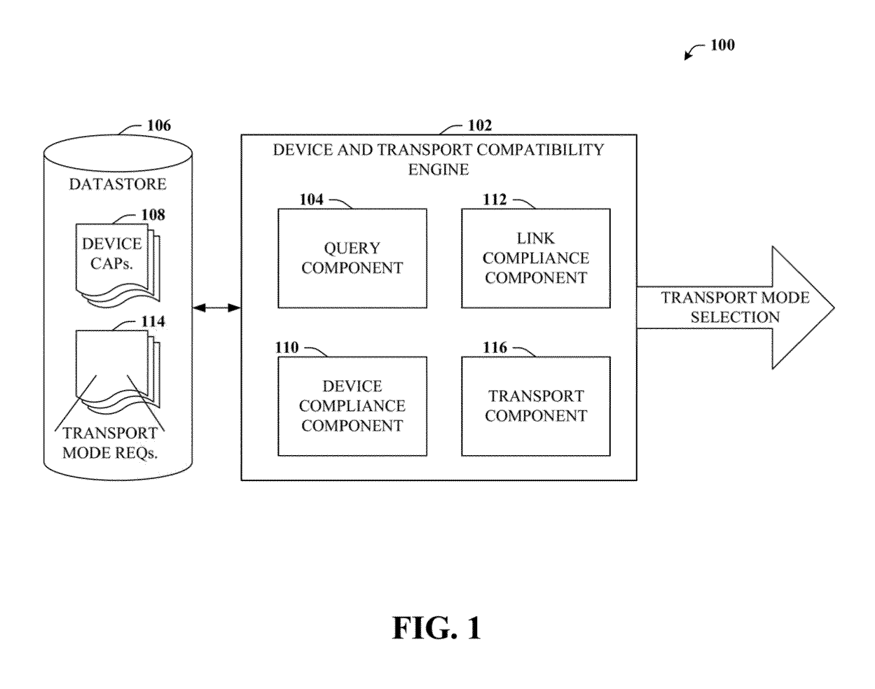

Referring now to the drawings, FIG. 1 illustrates a block diagram of an example system 100 for providing transport mode selection for mobile communications according to one or more aspects of the subject disclosure. Particularly, system 100 can be configured to request and obtain capabilities and characteristics of a communication link facilitating wireless communication service for a mobile device (not depicted), and provide an analysis of the communication link with respect to communication services supported for the mobile device. In some aspects, system 100 can be configured to obtain characteristics and capabilities of the mobile device, and analyze those characteristics and capabilities with respect to a particular communication service, such as a messaging service, a voice calling service, or a data service, such as streaming multimedia (e.g., streaming video and streaming audio). In at least one aspect, system 100 can be configured to obtain link characteristics or device characteristics of a remote device (e.g., a target device) and analyze the link characteristics or device characteristics in the context of a communication between the mobile device and the remote device. In this manner, system 100 can facilitate an objective analysis of transport modes and communication services available to provide communication between devices, in advance of such communication services being initiated on a device. In at least one aspect of the subject disclosure, system 100 can reside at least in part within a mobile device. In other aspects, system 100 can reside at least in part within a mobile communication service provider's network.

System 100 can comprise a device and transport compatibility engine 102, communicatively connected with a data store 106. Data store 106 can comprise a database, disk or disc storage, electronic memory, magnetic memory, or other suitable analog or digital data storage device, or a suitable combination thereof. In general, device and transport compatibility engine 102 can be configured to obtain wireless link characteristics and compare those characteristics to one or more conditions associated with a particular mobile communication service, and select a default or recommended transport mode for the mobile communication service.

As an example, voice over Internet Protocol (VoIP) can have conditions related to quality of service, available bandwidth, available data rate, jitter, or other network communication metrics. Current link characteristics can be compared with a related condition(s) for VoIP services, to determine effectiveness of such a service on a current link. Where multiple such links are available (e.g., where a mobile device concurrently observes multiple radio access networks (RANs), such as a global system for mobile communication (GSM) RAN, a universal mobile telecommunication systems (UMTS) RAN, and a third generation partnership project (3GPP) long term evolution (LTE) RAN), the determination can be made separately for respective links.

In other aspects, device and transport compatibility engine 102 can be configured to request and obtain mobile device characteristics, and analyze a service with respect to the mobile device characteristics. As a particular example of these aspects, a streaming video service might have conditions related to video processing speed, display resolution or graphical display speed. Device characteristics can be analyzed with respect to such conditions to determine whether a mobile device can support the streaming video service. In at least some aspects, both device characteristics and link characteristics can be analyzed with respect to a particular service. For instance, a device's graphical processing capability as well as a communication link(s)'s data rate can be analyzed with respect to graphical processing and data rate conditions of the streaming video service. In one or more particular aspects disclosed herein, the wireless link and device capabilities can be examined point-to-point for an originating device and a target device, as is described in more detail herein.

To the accomplishment of the foregoing ends and other ends disclosed herein, device and transport compatibility engine 102 can comprise a query component 104 configured to request a characteristic of a mobile communication link from a network serving a mobile communication device. The mobile communication link can comprise a wireless link communicatively connecting the mobile communication device with a RAN, or with another suitable wireless access point (e.g., a WiFi access point, a wireless interoperability for microwave access (WiMAX) access point, or the like). In some aspects, obtaining the characteristic of the mobile communication link can include a characteristic of a combined link, including the wireless link discussed above in conjunction with a backhaul link connecting a base station (or other wireless access point) with a mobile core network or a service provider's network (or a combination thereof). In some aspects, the combined link can include the wireless link, the backhaul link and an Internet link, for instance between the service provider's network or core network and the Internet or World Wide Web. In still other aspects, the combined link can include a point-to-point connection between an originating mobile device and target device, including all links involving in transmitting information for the point-to-point connection (e.g., originating wireless link, originating backhaul link, target backhaul link, target wireless link, and any intervening networks, such as the Internet, public switched telephone network (PSTN), or the like).

In addition to the above, query component 104 can be configured to request a feature of a mobile device served by system 100. As one example, depicted in FIG. 1, query component 104 can reference data store 106 and acquire device capabilities 108 stored in data store 106 pertaining to the mobile device. In other examples, query component 104 can be configured to send a request to the mobile device for a device capability thereof. Furthermore, query component 104 can be configured to request from a network serving the mobile device, a feature of a target communication device. Such a target communication device or identifying indicia related to such device might be selected from contact list information stored on the mobile device, or another suitable mechanism (e.g., user interface input on the mobile device, phone number selection, selection within a mobile device application such as a web browser, or the like). Once the identifying indicia are provided to the network, the network can attempt to request and obtain the target device information. If successful, this information can be returned to query component 104 in response to the request.

Device and transport compatibility engine 102 can further comprise a device compliance component 110. Device compliance component 110 can be configured to compare capabilities of the mobile device or a target device with conditions or requirements of a communication service and determine compatibility with the communication service at the mobile device, at the target device, or point-to-point for a communication between both devices. Thus, for instance, processing information (e.g., processing speed, onboard cache, firmware version, . . . ), memory information (e.g., memory capacity, available storage space, memory speed, memory timing, memory controller data, . . . ), wireless interface information (e.g., number of independent antennas, circuit-switched interface, packet-switched interface, GSM interface, UMTS interface, code division multiple access (CDMA) interface, wideband CDMA (W-CDMA) interface, high speed packet access (HSPA) interface, LTE interface, WiMAX interface, . . . ) application information (e.g., application type, application version, application service pack number, . . . ), user interface information (e.g., input information, output information), media playback information (e.g., audio playback capabilities, video playback capabilities, audio and video capabilities, audio codec, graphics resolution, graphics processing speed, graphics memory, video playback speed, and so on), or the like, or a suitable combination thereof, obtained from device capabilities 108 of the mobile device, or obtained for a target device in response to a request of query component 104, can be compared with the conditions or requirements of the communication service. Device compliance component 110 can, in particular aspects, be configured to perform an analysis to determine of the capabilities and conditions to estimate availability or quality of the communication service at least with respect to the device capabilities. Results of this analysis can be stored in memory (not depicted), output to a mobile device user interface, or the like.

Based on the foregoing, in at least one aspect, device compliance component 110 can be configured to compare a characteristic or feature of a target device with a corresponding characteristic or feature of the mobile device and determine compatibility of the mobile device and the target device with one of a set of communication transport modes connecting the devices. The transport modes can include one or more available wireless network connections (e.g., originating GSM link, originating LTE link, etc.), one or more intermediary connections (e.g., Internet connection, PSTN connection, . . . ), or a suitable combination thereof. Further, a link compliance component 112 can be configured to compare a characteristic or feature of one or more mobile communication links, transport modes, intermediary links, etc., acquired by query component 104, with a predefined link preference (e.g., a connection characteristic, such as data rate, bandwidth, jitter, quality of service, or the like, or a suitable combination thereof) stored in a transport mode requirements file 114 of data store 106, for one or more of a set of communication transport modes associated with the mobile device or target device.

Further to the above, device and transport compatibility engine 102 can comprise a transport component 116 configured to select one of the set of communication transport modes for a call between the mobile device and the target device. The selection can be based on device capabilities in relation to device conditions for the call, communication link capabilities in relation to transport mode conditions for the call, or a suitable combination thereof. Thus, in one instance, transport component 116 can be configured select the communication transport mode in response to determined compatibility for one or more of the devices satisfying a condition defined by a compatibility function. In another instance, transport component 116 can be configured to select the communication transport mode in response to the communication link characteristic(s) satisfying a second condition defined by a link preference function. In yet another instance, transport component 116 can be configured to select the communication transport mode in response to a combination of the foregoing.

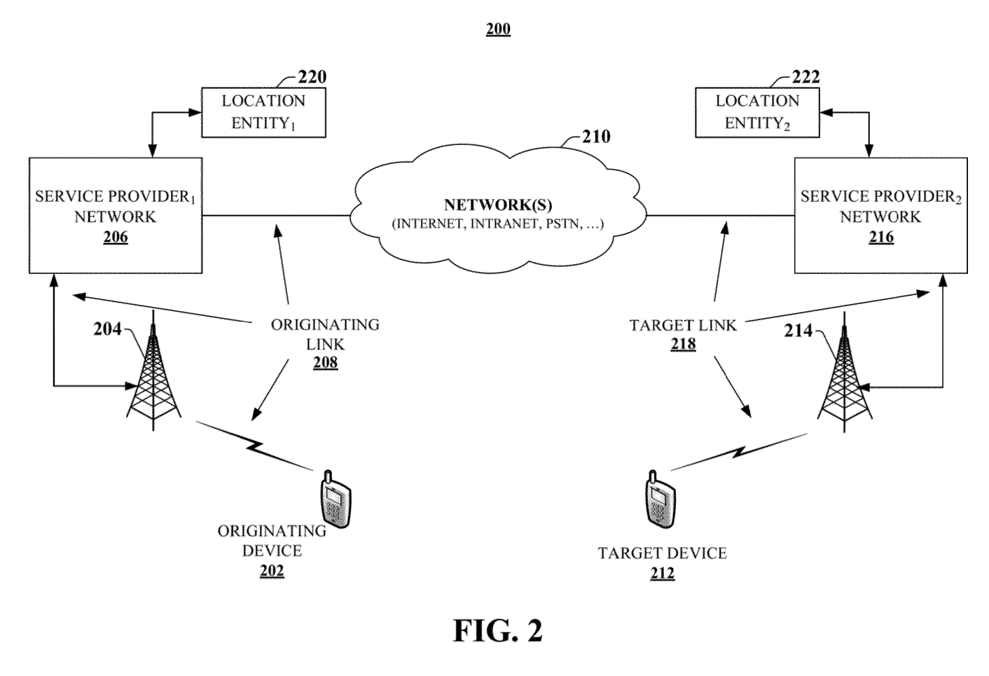

FIG. 2 depicts a block diagram of an example point-to-point communication link between devices participating in a mobile-related call, according to one or more aspects of the subject disclosure. As depicted, an originating mobile device 202 can be communicatively connected with one or more base stations 204 of one or more RANs. In some aspects, base station(s) 204 can instead be one or more wireless access points, such as a WiFi access point, a WiMAX access point, or the like. In particular aspects, originating mobile device 202 can be in wireless range of, or at least in part communicatively connected to, multiple base stations or access points, providing multiple possible wireless links for originating mobile device 202.

Base station(s) 204 are connected to a service provider network(s) 206, facilitating transmission of information from base station(s) 204 to one or more other networks 210. One or more other networks 210 can include another mobile service provider network, a PSTN, the Internet, a private intranet, a local wireless access network (LWAN), a wide area wireless access network (WWAN), or the like, or a combination thereof. In at least one aspect of the subject disclosure, an originating link 208 facilitating communication services for originating mobile device 202 can include a combination of a wireless link between originating mobile device and base station(s) 204, a backhaul link between base station(s) 204 and service provider(s) network(s) 206, and a connection between service provider(s) network(s) 206 and one or more other networks 210. In other aspects, originating link 208 can include a subset of these links and connections.

Originating mobile device 202 can select a target device 212 for a communication. The selection can be from a list of contacts, in at least one disclosed aspect. Such a communication can include a message communication (e.g., short message service (SMS) message, multimedia message service (MMS) message, text message, e-mail message, . . . ), a voice communication (e.g., a circuit-switched voice communication, a VoIP voice communication, a streaming voice communication, . . . ), a data communication (e.g., a browsing communication, download communication, upload communication, . . . ), or a media communication (e.g., streaming audio, streaming video, streaming audio and video, . . . ), or a suitable combination thereof. If present on a network, target device 212 can be connected to a target base station 214, via a target service provider network(s) 216, to one or more of network(s) 210, for instance.

In a particular aspect, service provider network(s) 206 can receive the selection of target device 212, and query service provider network(s) 216 to determine presence of target device 212 (e.g., where presence can be determined from whether target device is registered onto service provider network(s) 216, responds to a page by such service provider network(s), 216, or the like). Presence of target device 212 can be reported to service provider network(s) 206 by service provider network(s) 216. In an alternate or additional aspect, service provider network(s) 206 can query a location entity 220 (e.g., home location register, visiting location register, . . . ) associated with service provider network(s) 206, or a second location entity 222 associated with service provider network(s) 216, to determine presence of target device 212 for communication. Once determined, presence or lack thereof of target device 212 can be reported to originating mobile device 202 for display on a user interface of originating mobile device 202. In addition, characteristics of a target link 218 supporting target device 212 can at least in part be reported to originating device 202 to facilitate analysis of a point-to-point link between originating device 202 and target device 212. Target link 218 can include a wireless link between target device 212 and base station(s) 214, a backhaul link between base station(s) 214 and service provider network(s) 216, and a connection between service provider network(s) 216 and one or more network(s) 210, or a combination thereof. Characteristics of target link 218 to be reported to originating device 202 can include data rate, quality of service, bandwidth, jitter, or other suitable characteristics related to initiating, maintaining, supporting or optimizing voice or data communication services between originating device 202 and target device 212. These characteristics can be employed to analyze a point-to-point link between originating device 202 and target device 212 and determine compatibility with one or more such communication services.

In at least one aspect, originating device 202 can identify a set of possible transport modes between originating device 202 and target device 212. Different transport modes can occur, for instance, where different types of networks are accessible by originating device 202 and target device 212. For instance, where originating device 202 and target device 212 both are in range of a circuit-switched mobile network, network(s) 210 can include a PSTN, resulting in a purely circuit-switched transport mode connecting originating device 202 and target device 212. In another example, where originating device 202 or target device 212 are in range of both a packet-switched and a circuit-switched network, network(s) 210 can include both a packet-switched network (e.g., the Internet) and a circuit-switched network (e.g., a PSTN), resulting in a transport mode having a combined circuit-switched and packet-switched components. In other examples, originating device 202 and target device 212 can be in range of one or more different types of packet-switched networks, resulting in a wholly packet-switched transport mode, but based on differing technologies having different characteristics and capabilities. As a specific example to illustrate the latter examples, originating device 202 can be coupled with an LTE network having 10 megabit per second data rate, high quality of service and low jitter, and target device 212 can be coupled with a UMTS network having 2 megabit per second data rate, high quality of service and moderate jitter. A combined set of characteristics for a point-to-point connection between originating device 202 and target device 212 in this example can be, for instance, 2 megabit per second data rate, high quality of service and medium jitter.

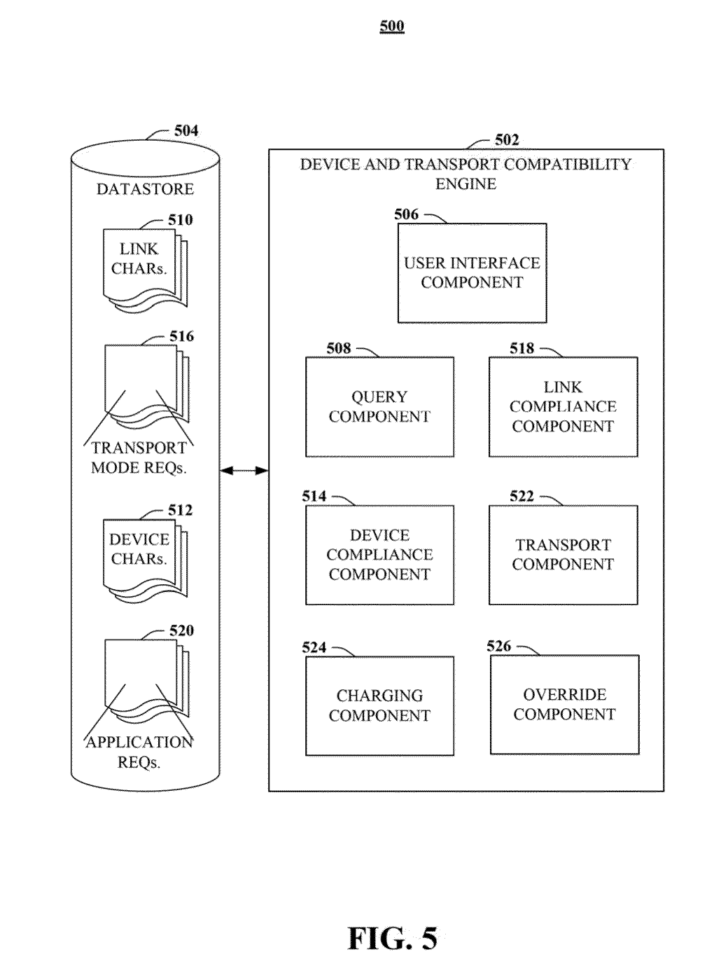

Once different network paths and transport modes are identified, a set of transport modes can be compiled at originating device 202. Respective sets of characteristics can be derived for the respective transport modes. The transport modes can be displayed at a user interface of originating device 202, along with the sets of characteristics, or an analysis thereof relative to one or more communication services of the originating device 202 or target device 212. In some aspects of the subject disclosure, respective charging rates for the respective transport modes can be derived for originating device 202 or target device 212, and displayed on the user interface of originating device 202, as described in more detail herein (e.g., see FIG. 5, infra).

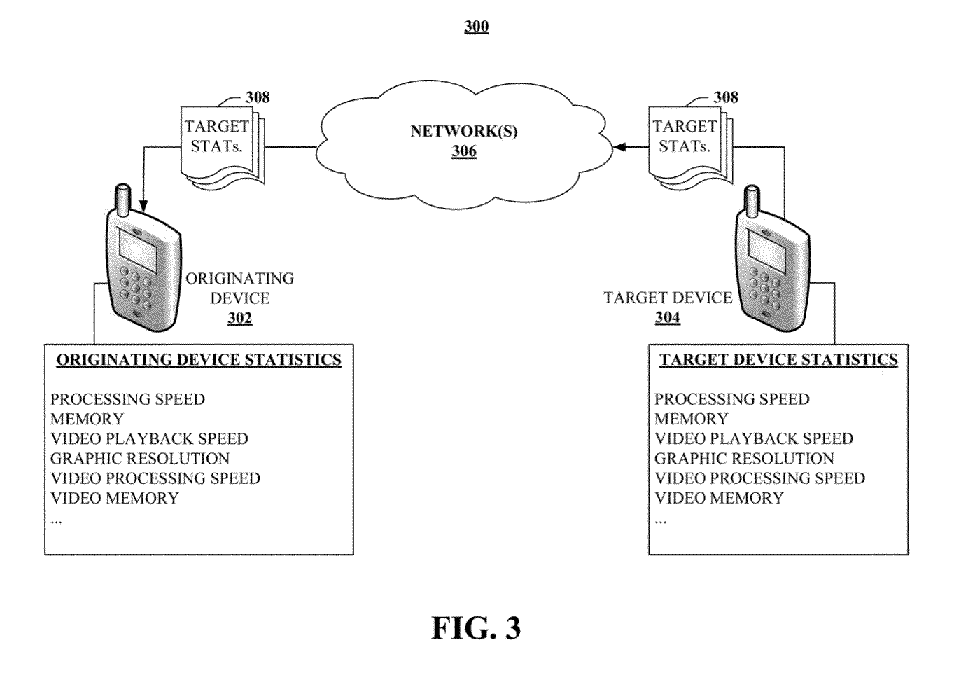

FIG. 3 illustrates a diagram of a mobile communication setup 300 according to further aspects of the subject disclosure. Mobile communication setup 300 can comprise an originating device 302 and a target device 304 communicatively coupled over one or more networks 306. Originating device 302 can comprise one or more systems (e.g., system 100 of FIG. 1, supra, system 500 of FIG. 5, infra, . . . ) configured to acquire characteristics pertaining to respective transport modes between originating device 302 and target device 304 (e.g., circuit-switched transport mode, packet-switched transport mode, part circuit-switched and part packet-switched transport mode, part third generation (3G) packet-switched transport mode and part fourth generation (4g) packet-switched transport mode, . . . ), as described herein. Additionally, the system(s) can be configured to request and obtain device characteristics of originating device 302 and target device 304.

Device statistics can include, for instance, processing speed, memory size, video playback speed, graphic resolution, video processing speed, video memory, audio codec, or any other suitable characteristic associated with providing communication services, or computing applications of originating device 302 or target device 304, or a suitable combination thereof. To acquire device statistics related to originating device 302, a system can access a data store on originating device 302 configured to store such information. To acquire device statistics related to target device 304, the system can send a request to target device 304, or to a network entity serving target device 304, and receive a target device statistics message 308 transmitted by target device 304 or the network serving target device 304. Features or characteristics of target device 304 extracted from target device statistics message 308 can then be reference against originating device statistics to determine device compatibility with one or more communication services conducted between originating device 302 and target device 304.

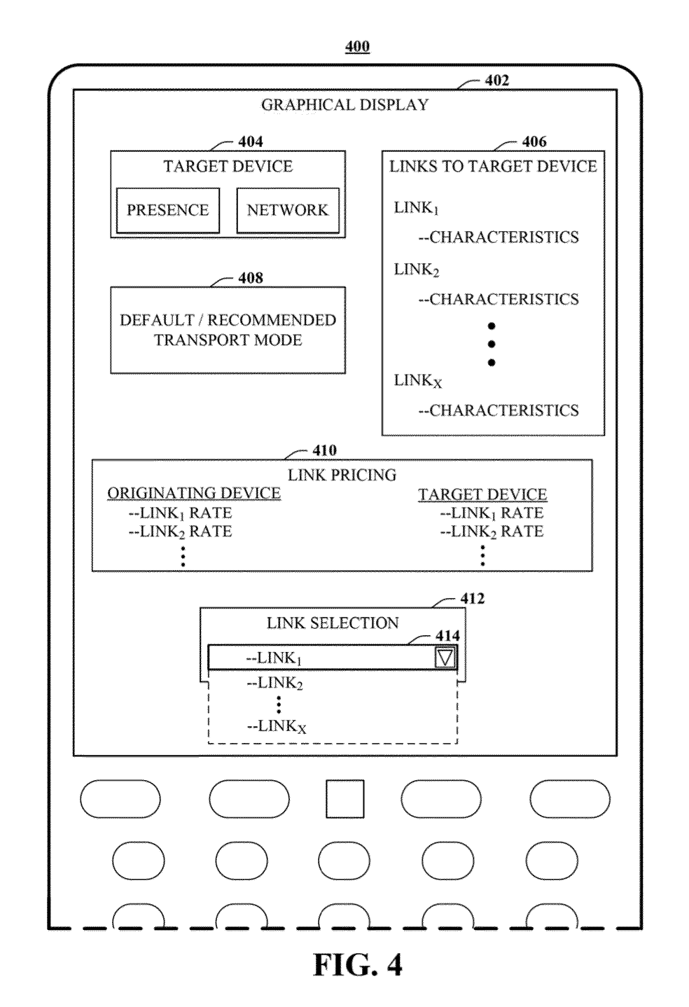

FIG. 4 illustrates a block diagram of an example mobile device user interface 400 for integrating user feedback or user input with automatic transport mode selection for mobile communications, according to one or more further aspects of the subject disclosure. Mobile device user interface 400 can comprise a graphical display 402, which can comprise any suitable graphical display for a computing device. As an example, graphical display 402 can comprise a flat-screen display. As another example, graphical display 402 can comprise a liquid crystal display, a light emitting diode display, a plasma display, or other suitable display. Further, graphical display 402 can have a native video resolution for graphical display of information.

As depicted, graphical display 402 can comprise one or more icons, indicators, information boxes, drop-down boxes, or other suitable graphical information display devices. A first display 404 can include a target device information box, indicating network presence of the target device, and optionally network on which the target device is being served. A second display 406 can include a links to target device display, which displays a list of respective transport modes connecting an originating device with the target device. Optionally, second display 406 can further provide characteristics of the respective transport modes (e.g., packet loss, quality of service, data rate, bandwidth, . . . ) or respective analysis of the respective transport modes relative to one or more communication services or media services (e.g., indicating a degree of link support for respective services). Based on the target device selected and displayed in first display 404, and transport mode characteristics identified within second display 406, graphical display can output a default or recommended transport mode within a third display 408. The default or recommended transport mode can comprise a transport mode that best satisfies a first point-to-point condition pertaining to device capabilities and a second point-to-point condition pertaining to link capabilities for one or more respective services.

Graphical display 402 can further comprise a fourth display 410 indicating charging rates for respective links at least for the originating device, and optionally for the target device. Moreover, a fifth display 410 can provide a link selection interface having a link display box 414 with available links, e.g., link₁, link₂, . . . linkₓ, where X is a suitable integer. A selection in link selection interface can be utilized to initiate a communication service with the target device. In some aspects, a link selection can override the default/recommended transport mode output to third display 408 (e.g., see FIG. 5, infra).

FIG. 5 depicts a block diagram of an example system 500 according to aspects of the subject disclosure. System 500 can comprise a device and transport compatibility engine 502 communicatively connected with a data store 504. Device and transport compatibility engine 504 can comprise a user interface component 506 configured to output information to a user interface of a mobile device, and to receive information input into the mobile device. In a particular aspect, user interface component 506 can be configured to receive a user input identifying a target device for mobile communication with the mobile device.

Further, device and transport compatibility component 502 can comprise a query component 508 configured to access data store 504 and obtain device characteristics 512 associated with the mobile device, and obtain link characteristics 510 of a set of wireless links available to the mobile device. Query component 508 can further be configured to send a request and receive device characteristics of the target device (e.g., from the target device, or from a network serving the target device), or send a request and receive link characteristics of the target device from a network serving the target device. Additionally, device and transport compatibility component 502 can comprise a device compliance component 514 that compares device capabilities to one or more application or service requirements 520 of a service or application of the mobile device, stored in data store 504. Moreover, device and transport compatibility component 502 can comprise a link compliance component 518 configured to compare link characteristics associated with the mobile device or the target device, and compare the characteristics with a set of transport mode requirements 516 stored in data store 504. Based at least in part on the device characteristic comparisons or link characteristic comparisons, a transport component 522 can be configured to select respective transport modes for respective services. Selection can be based on which transport mode most satisfies a condition for the respective services. The condition can be based on satisfaction of device requirements, or satisfaction of transport mode requirements, in one aspect. In another aspect, the condition can alternatively or in addition incorporate billing rate requirements, or other user-provided user requirements of a user of the mobile device.

Device and transport compatibility engine 502 can comprise a charging component 524 configured to obtain link pricing information for respective services of the mobile device, on respective transport modes. Charging component 524 can query serving networks supporting the mobile device and the target device to determine applicable billing rates for respective links, and for respective services. For instance, a network could charge a different rate when roaming as opposed to being within a home network (e.g., in which a serving network maintains a service subscription for the mobile device, or target device). Charging component 524 can be further configured to output charging rates for different services for the mobile device or the target device to user interface component 506, for output to a user interface of the mobile device.

In at least one aspect, device and transport compatibility engine 502 can comprise a user override component 526 configured to obtain an input from the user interface of the mobile device. This input can be a transport mode selection (e.g., a wireless link selection) identifying a user-selected transport mode for a call or communication service. User override component 526 can be further configured to cancel or confirm a default or recommended transport mode selection of transport component 522, with the user-selected transport mode obtained from the user interface.

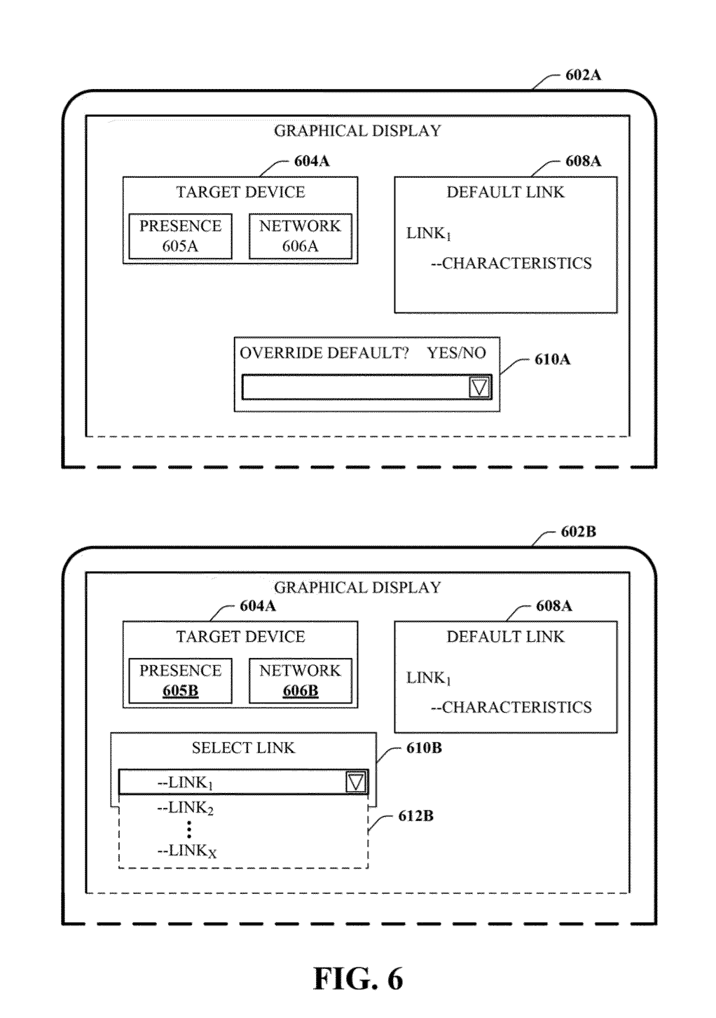

FIG. 6 illustrates a diagram of example user interface displays for a mobile device according to further aspects of the subject disclosure. Particularly, depicted is a first user interface display 602A and second user interface display 602B. First user interface display 602A can comprise a target window 604A indicating a target mobile device selected at a user interface of a mobile device. The target window 604A can include a presence indicator 605A indicating presence or non-presence of the selected target mobile device, and a network indicator 606A optionally indicating a serving network(s) for the selected target mobile device. Additionally, a default link indicator 608A can display a default or recommended link for connected the mobile device to a service provider, and an override default link indicator 610A, that enables user input at the mobile device to override or not override the default or recommended link.

A second user interface display 602B can be displayed at a user interface of the mobile device upon selecting to override the default or recommended link. The override default link indicator 610A can be replaced with a link selection indicator 610B, having a list 612B of available wireless links or transport modes for connecting the mobile device to a server provider network. A user input selection can select one of the available wireless links or transport modes, and the selection can be implemented by the mobile device as a wireless link or transport mode for connecting to the service provider's network or for establishing a communication session with the target mobile device.

The aforementioned diagrams have been described with respect to interaction between several systems, apparatuses, components, user interfaces, and display indicators. It should be appreciated that such diagrams can include those components or systems specified therein, some of the specified components, or additional components. For example, a system could include system 100 comprising device and transport compatibility engine 502, and data store 504, and graphical display 400. Sub-components could also be implemented as components electrically connected to other sub-components rather than included within a parent component. Additionally, it should be noted that two or more components could be combined into a single component providing aggregate functionality. For instance, link compliance component 112 can include device compliance component 214 to facilitate analyzing or comparing device and link capabilities of a mobile device(s) with application, wireless link, or service provider requirements, by way of a single component. Components of the disclosed systems and apparatuses can also interact with one or more other components not specifically described herein but known by those of skill in the art, or made known to one of skill in the art by way of the context provided herein.

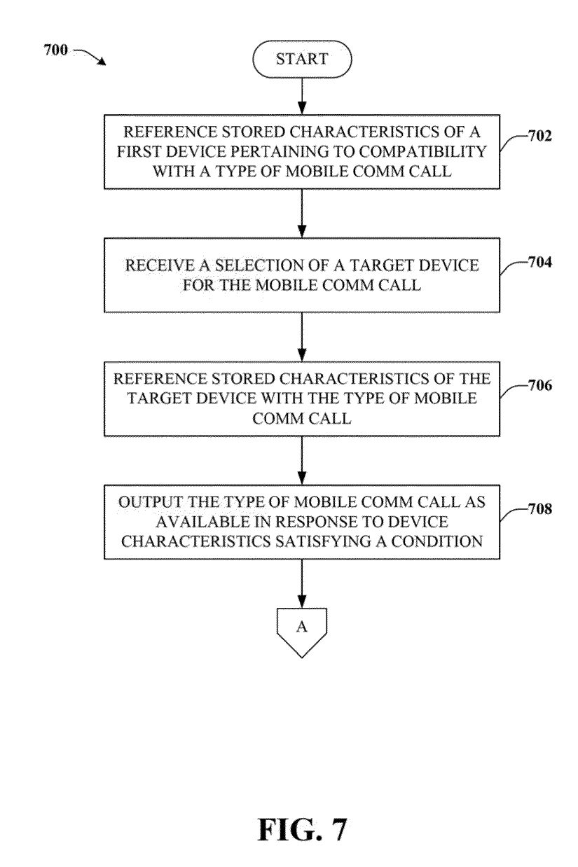

In view of the exemplary diagrams described supra, process methods that may be implemented in accordance with the disclosed subject matter will be better appreciated with reference to the flow chart of FIGS. 7-9. While for purposes of simplicity of explanation, the methods are shown and described as a series of blocks, it is to be understood and appreciated that the disclosed subject matter is not limited by the order of the blocks, as some blocks may occur in different orders and/or concurrently with other blocks from what is depicted and described herein. Moreover, not all illustrated blocks may be required to implement the methods described hereinafter. Additionally, it should be further appreciated that the methods disclosed hereinafter and throughout this specification are capable of being stored on an article of manufacture to facilitate transporting and transferring such methods to an electronic device. The term article of manufacture, as used, is intended to encompass a computer program accessible from any computer-readable device, device in conjunction with a carrier, or storage medium.

FIG. 7 illustrates a flowchart of a sample method 700 for providing automated transport mode selection for mobile communications according to additional aspects of the subject disclosure. At 702, method 700 can comprise referencing stored characteristics of a first device pertaining to compatibility with a type of mobile communication call. At 704, method 700 can comprise receiving a selection of a target device for the mobile communication call. At 706, method 700 can comprise referencing stored characteristics of the target device pertaining to compatibility with the type of mobile communication call. Moreover, at 708, method 700 can comprise outputting the type of mobile communication call as available at least in response to the stored characteristics of the first device and stored characteristics of the target device satisfying a condition of the type of the mobile communication call. In at least one optional aspect, method 700 can additionally comprise obtaining wireless link characteristics of a wireless link available for the first device and wireless link characteristics of a second wireless link of the target device, and conditioning outputting the type of mobile communication call as available upon the wireless link characteristics satisfying a condition defined by a wireless link requirement function.

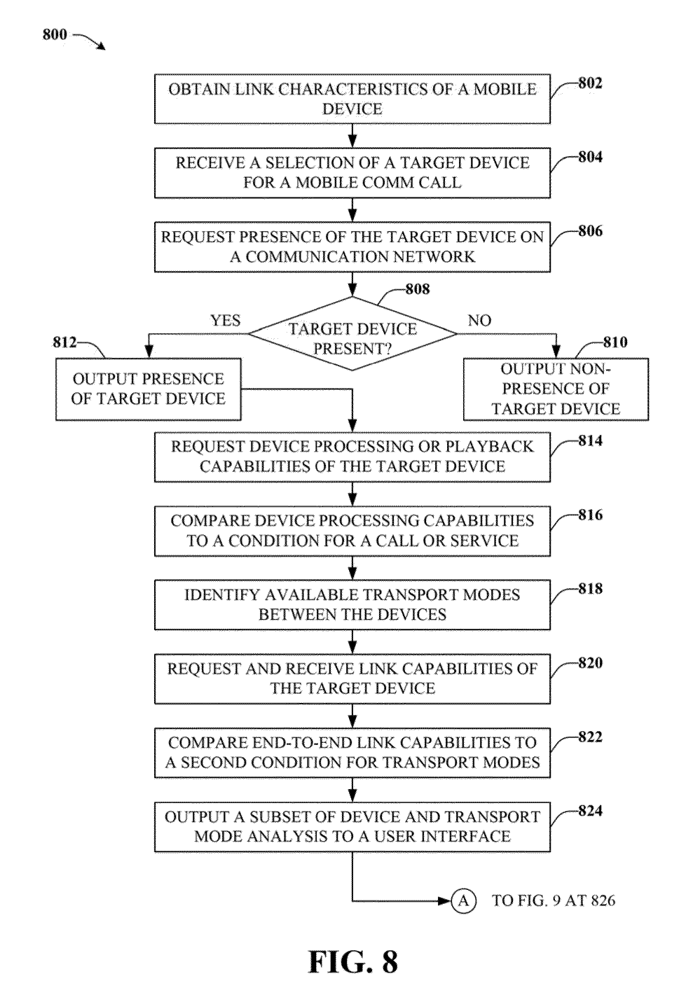

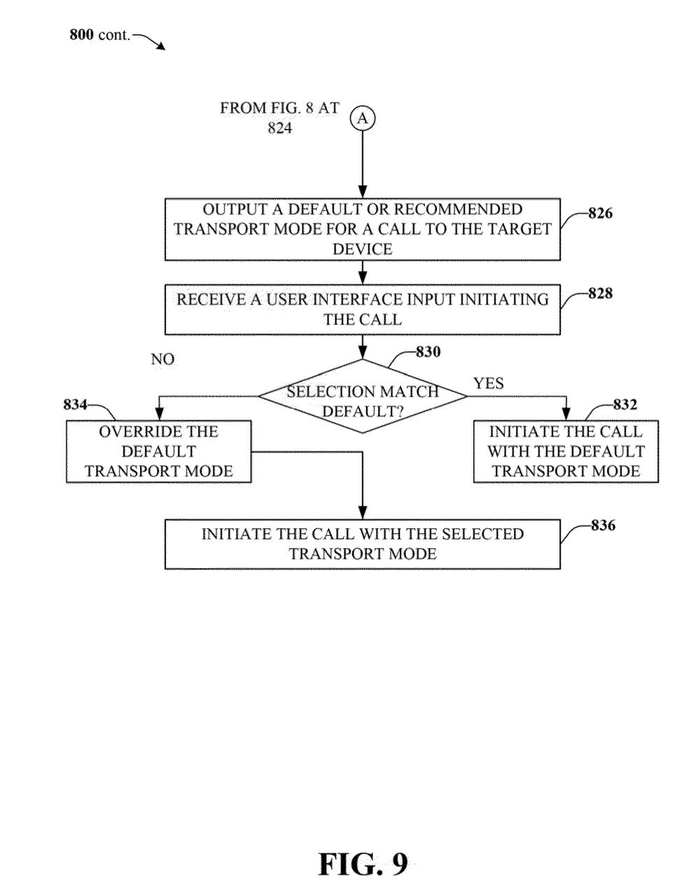

FIGS. 8 and 9 illustrate a flowchart of an example method 800 for providing point-to-point analysis of wireless communication services for mobile communications, according to yet other aspects of the subject disclosure. At 802, method 800 can comprise obtaining a link characteristic(s) of a wireless link serving or suitable for serving a mobile device. At 804, method 800 can comprise receiving a selection of a target device for a mobile communication call. At 806, method 800 can comprise requesting presence of the target device on a communication network. At 808, method 800 can comprise determining whether the target device is present on the communication network. If the target device is not present, method 800 can proceed to 810, where non-presence of the target device can be output to a user interface of the mobile device. Otherwise, method 800 can proceed to 812.

At 812, method 800 can comprise outputting presence of the target device on the communication network. At 814, method 800 can comprise requesting device processing or playback capabilities of the target device. At 816, method 800 can comprise comparing device processing capabilities to a condition associated with initiating or maintaining a call or communication service. At 818, method 800 can comprise identifying available transport modes between the mobile device and the target device. At 820, method 800 can comprise requesting and receiving link capabilities of the target device. At 822, method 800 can comprise comparing end-to-end link capabilities to a second condition associated with transport modes for the call or communication service. At 824, method 800 can comprise outputting a subset of device and transport mode analysis to a user interface of the mobile device.

Referring to FIG. 9, at 826, method 800 can comprise outputting a default or recommended transport mode for a call to the target device. At 828, method 800 can comprise receiving a user interface input initiating the call or communication service. At 830, a determination is made as to whether a transport mode selection obtained from a user interface of the mobile device matches the default or recommended transport mode. If the selection from the user interface matches the default or recommended transport mode, method 800 can proceed to 832 and initiate the call or communication service with the default transport mode. Otherwise, method 800 can proceed to 834 and override the default transport mode. At 836, method 800 can comprise initiating the call with the selected transport mode instead of the default or recommended transport mode.

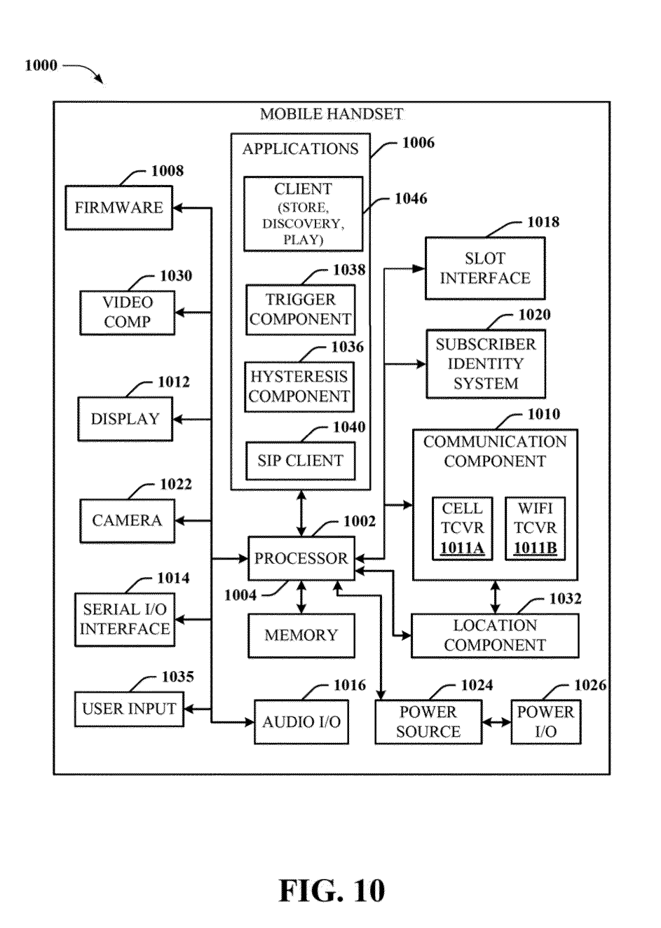

Referring now to FIG. 10, illustrated is a schematic block diagram of an exemplary mobile device 1000 capable of requesting or providing third-party funding for electronic commerce initiated by mobile device 1000 or another device, in accordance with some embodiments described herein. Although a mobile handset 1000 is illustrated herein, it will be understood that other devices can be a mobile device, and that the mobile handset 1000 is merely illustrated to provide context for the embodiments of the innovation described herein. The following discussion is intended to provide a brief, general description of an example of a suitable environment 1000 in which the various disclosed embodiments can be implemented. While the description includes a general context of computer-executable instructions embodied on a computer readable storage medium, those skilled in the art will recognize that the innovation also can be implemented in combination with other program modules or as a combination of hardware, software or firmware.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices. Further, illustrated aspects of the subject disclosure can be practiced in distributed computing environments where certain tasks are performed by remote processing devices that are linked through a communications network (e.g., multiple mobile handsets 1000 communicating with peer-to-peer signaling, or through a mobile communication network). In a distributed computing environment, systems and system components, as well as program modules can be located in both local and remote memory storage devices (e.g., data store 104 located remotely from device and transport compatibility engine 102).

A computing device such as mobile handset 1000 can typically include a variety of media, which can include computer-readable storage media or communication media, which two terms are used herein differently from one another as follows.

Computer readable storage media can be any available storage media that can be accessed by a computer (e.g., mobile handset 1000) and includes both volatile and nonvolatile media, removable and non-removable media. By way of example and not limitation, computer-readable storage media can be implemented in connection with any method or technology for storage of information, such as computer-readable instructions, data structures, program modules or unstructured data. Computer-readable storage media can include, but is not limited to, RAM, ROM, EEPROM, flash memory or other memory technology, CD ROM, digital versatile disk (DVD) or other optical disk storage, magnetic cassettes, magnetic tape, magnetic disk storage or other magnetic storage devices, or other tangible or non-transitory media which can be used to store desired information. Computer-readable storage media can be accessed by one or more local or remote computing devices, e.g., via access requests, queries or other data retrieval protocols, for a variety of operations with respect to the information stored by the medium.

Communication media typically embodies computer-readable instructions, data structures, program modules or other structured or unstructured data in a modulated data signal such as a carrier wave or other transport mechanism, and includes any suitable information delivery or transport media. The term “modulated data signal” or signals means a signal that has one or more of its characteristics set or changed in such a manner as to encode information in one or more signals. By way of example, and not limitation, communication media includes wired media such as a wired network or direct-wired connection, and wireless media such as acoustic, RF, infrared and other wireless media.

Mobile handset 1000 includes a processor 1002 for controlling and processing onboard operations and functions. A memory 1004 interfaces to the processor 1002 for storage of data and one or more applications 1006 (e.g., a video player software, user feedback or user input component software, etc.). Other applications can include voice recognition of predetermined voice commands that facilitate receipt of user input. The applications 1006 can be stored in the memory 1004 and/or in a firmware 1008, and executed by the processor 1002 from either or both the memory 1004 or the firmware 1008. The firmware 1008 can also store startup code for execution in initializing mobile handset 1000. A communications component 1010 interfaces to the processor 1002 to facilitate wired/wireless communication with external systems, e.g., cellular networks, VoIP networks, and so on. Here, the communications component 1010 can also include a suitable cellular transceiver 1011A (e.g., a GSM transceiver) or an unlicensed transceiver 1011B (e.g., WiFi, WiMAX) for corresponding signal communications. Mobile handset 1000 can be a device such as a cellular telephone, a PDA with mobile communications capabilities, and messaging-centric devices. The communications component 1010 also facilitates communications reception from terrestrial radio networks (e.g., broadcast), digital satellite radio networks, and Internet-based radio services networks.

Mobile handset 1000 includes a display 1012 for displaying text, images, video, telephony functions (e.g., a Caller ID function), setup functions, and for user input. For example, the display 1012 can also be referred to as a “screen” that can accommodate the presentation of multimedia content (e.g., music metadata, messages, wallpaper, graphics, etc.). The display 1012 can also display videos and can facilitate the generation, editing and sharing of graphical or video applications. A serial I/O interface 1014 is provided in communication with the processor 1002 to facilitate wired and/or wireless serial communications (e.g., USB, and/or IEEE 1094) through a hardwire connection, and other serial input devices (e.g., a keyboard, keypad, and mouse). This supports updating and troubleshooting mobile handset 1000, for example. Audio capabilities are provided with an audio I/O component 1016, which can include a speaker for the output of audio signals related to, for example, indication that the user pressed the proper key or key combination to initiate the user feedback signal. The audio I/O component 1016 also facilitates the input of audio signals through a microphone to record data and/or telephony voice data, and for inputting voice signals for telephone conversations.

Mobile handset 1000 can include a slot interface 1018 for accommodating a SIC (Subscriber Identity Component) in the form factor of a card Subscriber Identity Module (SIM) or universal SIM 1020, and interfacing the SIM card 1020 with the processor 1002. However, it is to be appreciated that the SIM card 1020 can be manufactured into the handset 1000, and updated by downloading data and software.

The handset 1000 can process IP data traffic through the communication component 1010 to accommodate IP traffic from an IP network such as, for example, the Internet, a corporate intranet, a home network, a person area network, etc., through an ISP or broadband cable provider. Thus, VoIP traffic can be utilized by the handset 1000 and IP-based multimedia content can be received in either an encoded or decoded format.

A graphics processing component 1022 (e.g., a camera) can be provided for decoding encoded multimedia content. The graphics processing component 1022 can aid in facilitating the generation, playback, editing and sharing of graphical media. Mobile handset 1000 also includes a power source 1024 in the form of batteries and/or an AC power subsystem, which power source 1024 can interface to an external power system or charging equipment (not shown) by a power I/O component 1026.

Mobile handset 1000 can also include a video component 1030 for processing video content received and, for recording and transmitting video content. For example, the video component 1030 can facilitate the generation, editing and sharing of video media. A location tracking component 1032 facilitates geographically locating mobile handset 1000. A user input component 1034 facilitates the user inputting information, responses or selections into mobile handset 1000. The user input component 1034 can include such conventional input device technologies such as a keypad, keyboard, mouse, stylus pen, or touch screen, for example. Information provided to user input component 1034 can be used for selecting or overriding a transport mode for mobile communication, or sending messaging content in conjunction with a request for wireless or device capabilities of mobile handset 1000 or a related mobile handset.

Referring again to the applications 1006, a hysteresis component 1036 facilitates the analysis and processing of hysteresis data, which is utilized to determine when to associate with an access point. A software trigger component 1038 can be provided that facilitates triggering of the hysteresis component 1038 when the WiFi transceiver 1013 detects the beacon of the access point. A SIP client 1040 enables the handset 1000 to support SIP protocols and register the subscriber with the SIP registrar server. The applications 1006 can also include a client 1042 that provides at least the capability of discovery, play and store of multimedia content, for example, music.

Mobile handset 1000, as indicated above related to the communications component 1010, includes an indoor network radio transceiver 1011B (e.g., WiFi transceiver). This function supports the indoor radio link, such as IEEE 802.11, in the event mobile handset 1000 comprises a dual-mode GSM handset. Mobile handset 1000 can accommodate at least satellite radio services through a handset that can combine wireless voice and digital radio chipsets into a single handheld device.

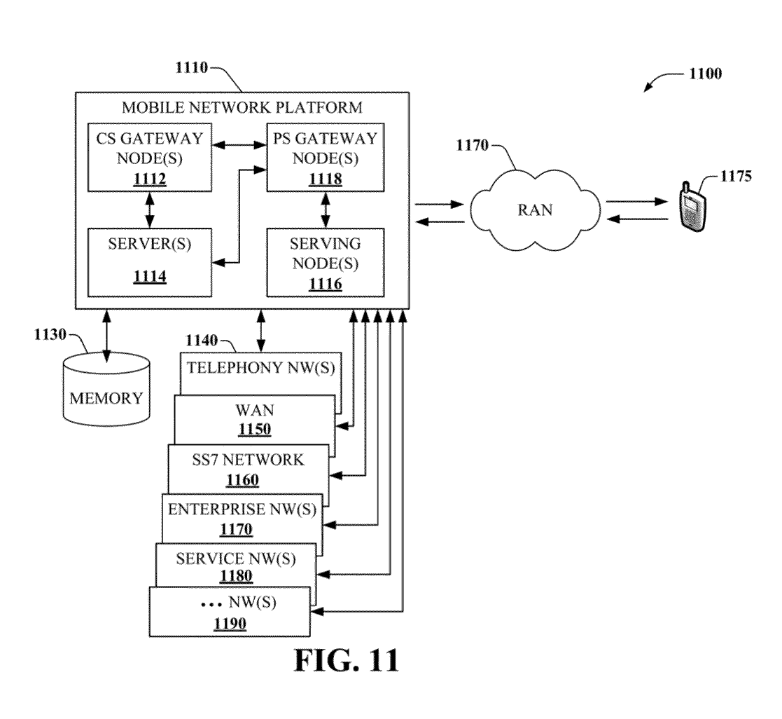

FIG. 11 presents an example embodiment 1100 of a mobile network platform 1110 that can implement and exploit one or more aspects of the disclosed subject matter described herein. Generally, wireless network platform 1110 can include components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. Mobile network platform 1110 includes CS gateway node(s) 1112 which can interface CS traffic received from legacy networks like telephony network(s) 1140 (e.g., public switched telephone network (PSTN), or public land mobile network (PLMN)) or a signaling system #7 (SS7) network 1170. Circuit switched gateway node(s) 1112 can authorize and authenticate traffic (e.g., voice) arising from such networks. Additionally, CS gateway node(s) 1112 can access mobility, or roaming, data generated through SS7 network 1170; for instance, mobility data stored in a visited location register (VLR), which can reside in memory 1130. Moreover, CS gateway node(s) 1112 interfaces CS-based traffic and signaling and PS gateway node(s) 1118. As an example, in a 3GPP UMTS network, CS gateway node(s) 1112 can be realized at least in part in gateway GPRS support node(s) (GGSN). It should be appreciated that functionality and specific operation of CS gateway node(s) 1112, PS gateway node(s) 1118, and serving node(s) 1116, is provided and dictated by radio technology(ies) utilized by mobile network platform 1110 for telecommunication.

In the disclosed subject matter, in addition to receiving and processing CS-switched traffic and signaling, PS gateway node(s) 1118 can authorize and authenticate PS-based data sessions with served mobile devices. Data sessions can include traffic, or content(s), exchanged with networks external to the wireless network platform 1110, like wide area network(s) (WANs) 1150, enterprise network(s) 1170, and service network(s) 1180, which can be embodied in local area network(s) (LANs), can also be interfaced with mobile network platform 1110 through PS gateway node(s) 1118. It is to be noted that WANs 1150 and enterprise network(s) 1160 can embody, at least in part, a service network(s) like IP multimedia subsystem (IMS). Based on radio technology layer(s) available in technology resource(s) 1117, packet-switched gateway node(s) 1118 can generate packet data protocol contexts when a data session is established; other data structures that facilitate routing of packetized data also can be generated. To that end, in an aspect, PS gateway node(s) 1118 can include a tunnel interface (e.g., tunnel termination gateway (TTG) in 3GPP UMTS network(s) (not shown)) which can facilitate packetized communication with disparate wireless network(s), such as Wi-Fi networks.

In embodiment 1100, wireless network platform 1110 also includes serving node(s) 1116 that, based upon available radio technology layer(s) within technology resource(s) 1117, convey the various packetized flows of data streams received through PS gateway node(s) 1118. It is to be noted that for technology resource(s) 1117 that rely primarily on CS communication, server node(s) can deliver traffic without reliance on PS gateway node(s) 1118; for example, server node(s) can embody at least in part a mobile switching center. As an example, in a 3GPP UMTS network, serving node(s) 1116 can be embodied in serving GPRS support node(s) (SGSN).

For radio technologies that exploit packetized communication, server(s) 1114 in wireless network platform 1110 can execute numerous applications (e.g., location services, online gaming, wireless banking, wireless device management, wireless link characterization, mobile device capability acquisition, . . . ) that can generate multiple disparate packetized data streams or flows, and manage (e.g., schedule, queue, format . . . ) such flows. Such application(s) can include add-on features to standard services (for example, provisioning, billing, customer support . . . ) provided by wireless network platform 1110. Data streams (e.g., content(s) that are part of a voice call or data session) can be conveyed to PS gateway node(s) 1118 for authorization/authentication and initiation of a data session, and to serving node(s) 1116 for communication thereafter. In addition to application server, server(s) 1114 can include utility server(s); a utility server can include a provisioning server, an operations and maintenance server, a security server that can implement at least in part a certificate authority and firewalls as well as other security mechanisms, and the like. In an aspect, security server(s) secure communication served through wireless network platform 1110 to ensure network's operation and data integrity in addition to authorization and authentication procedures that CS gateway node(s) 1112 and PS gateway node(s) 1118 can enact. Moreover, provisioning server(s) can provision services from external network(s) like networks operated by a disparate service provider; for instance, WAN 1150 or Global Positioning System (GPS) network(s) (not shown). Provisioning server(s) can also provision coverage through networks associated to wireless network platform 1110 (e.g., deployed and operated by the same service provider), such as Femto cell network(s) (not shown) that enhance wireless service coverage within indoor confined spaces and offload RAN resources in order to enhance subscriber service experience within a home or business environment.

It is to be noted that server(s) 1114 can include one or more processors configured to confer at least in part the functionality of macro network platform 1110. To that end, the one or more processor can execute code instructions stored in memory 1130, for example. It is should be appreciated that server(s) 1114 can include a content manager 1115, which operates in substantially the same manner as described hereinbefore.

In example embodiment 1100, memory 1130 can store information related to operation of wireless network platform 1110. In particular, memory 1130 can include contents of data store 106 in example system 100, or data store 504 in example system 500. Other operational information can include provisioning information of mobile devices served through wireless platform network 1110, subscriber databases, application intelligence, pricing schemes, e.g., promotional rates, flat-rate programs, couponing campaigns, technical specification(s) consistent with telecommunication protocols for operation of disparate radio, or wireless, technology layers, and so forth. Memory 1130 can also store information from at least one of telephony network(s) 1140, WAN 1150, enterprise network(s) 1160, or SS7 network 1170.

It is to be noted that aspects, features, or advantages of the disclosed subject matter described in the subject specification can be exploited in substantially any wireless communication technology. For instance, Wi-Fi, WiMAX, Enhanced GPRS, 3GPP LTE, 3GPP2 UMB, 3GPP UMTS, HSPA, HSDPA, HSUPA, GERAN, UTRAN, LTE Advanced. Additionally, substantially all aspects of the disclosed subject matter as disclosed in the subject specification can be exploited in legacy telecommunication technologies, e.g., GSM. In addition, mobile as well non-mobile networks (e.g., internet, data service network such as internet protocol television (IPTV)) can exploit aspects or features described herein.

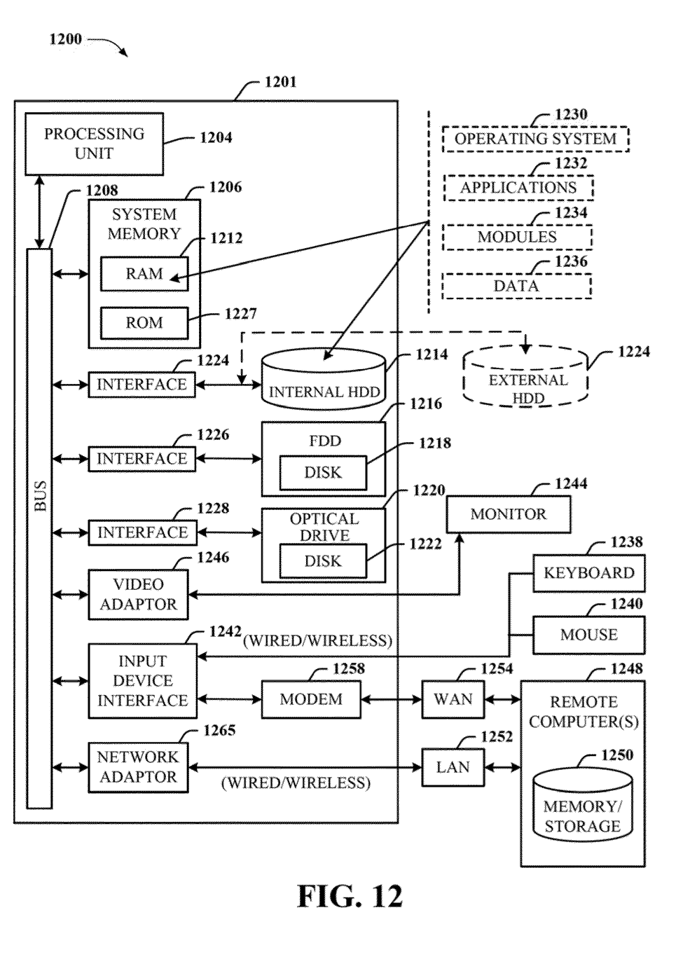

With reference to FIG. 12, an exemplary environment 1200 for implementing various aspects described herein includes a computer 1202, the computer 1202 including a processing unit 1204, a system memory 1206 and a system bus 1208. The system bus 1208 connects system components including, but not limited to, the system memory 1206 to the processing unit 1204. The processing unit 1204 can be any of various commercially available processors. Dual microprocessors and other multi processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes read-only memory (ROM) 1210 and random access memory (RAM) 1212. A basic input/output system (BIOS) is stored in a non-volatile memory 1210 such as ROM, EPROM, EEPROM, which BIOS contains the basic routines that help to transfer information between elements within the computer 1202, such as during start-up. The RAM 1212 can also include a high-speed RAM such as static RAM for caching data.

The computer 1202 further includes an internal hard disk drive (HDD) 1214 (e.g., EIDE, SATA), which internal hard disk drive 1214 can also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1211 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE 1294 interface technologies. Other external drive connection technologies are within contemplation of the subject innovation.

The drives and their associated computer-readable media provide nonvolatile storage of data, data structures, computer-executable instructions, and so forth. For the computer 1202, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the exemplary operating environment, and further, that any such media can contain computer-executable instructions for performing the methods of the disclosed innovation.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. It is to be appreciated that the innovation can be implemented with various commercially available operating systems or combinations of operating systems.

A user can enter commands and information into the computer 1202 through one or more wired/wireless input devices, e.g., a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE 2394 serial port, a game port, a USB port, an IR interface, etc.

A monitor 1244 or other type of display device is also connected to the system bus 1208 through an interface, such as a video adapter 1246. In addition to the monitor 1244, a computer typically includes other peripheral output devices (not shown), such as speakers, printers, etc.

The computer 1202 can operate in a networked environment using logical connections by wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which may connect to a global communications network, e.g., the Internet.

When used in a LAN networking environment, the computer 1202 is connected to the local network 1252 through a wired and/or wireless communication network interface or adapter 1256. The adapter 1256 may facilitate wired or wireless communication to the LAN 1252, which may also include a wireless access point disposed thereon for communicating with the wireless adapter 1256.

When used in a WAN networking environment, the computer 1202 can include a modem 1258, or can be connected to a communications server on the WAN 1254, or has other means for establishing communications over the WAN 1254, such as by way of the Internet. The modem 1258, which can be internal or external and a wired or wireless device, is connected to the system bus 1208 through the serial port interface 1242. In a networked environment, program modules depicted relative to the computer 1202, or portions thereof, can be stored in the remote memory/storage device 1250. It will be appreciated that the network connections shown are exemplary and other means of establishing a communications link between the computers can be used.

The computer 1202 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least WiFi and Bluetooth™ wireless technologies. Thus, the communication can be a predefined structure as with a conventional network or simply an ad hoc communication between at least two devices.

WiFi, or Wireless Fidelity, allows connection to the Internet from a couch at home, a bed in a hotel room, or a conference room at work, without wires. WiFi is a wireless technology similar to that used in a cell phone that enables such devices, e.g., computers, to send and receive data indoors and out—anywhere within the range of a base station. WiFi networks use radio technologies called IEEE 802.11(a, b, g, etc.) to provide secure, reliable, fast wireless connectivity. A WiFi network can be used to connect computers to each other, to the Internet, and to wired networks (which use IEEE 802.3 or Ethernet). WiFi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

What is claimed is:

1. A system facilitating mobile communications, comprising:
a query component configured to request a characteristic of a mobile communication link from a network serving a first mobile communication device, and to request from the network a feature of a target communication device;
a device compliance component configured to compare the feature of the target communication device with a corresponding feature of the first mobile communication device and determine a compatibility of the first mobile communication device and the target communication device with one of a set of communication transport modes;
a link compliance component configured to compare the characteristic of the mobile communication link with a predefined link preference of the one of the set of communication transport modes; and
a transport component configured to select the one of the set of communication transport modes for a call between the first mobile communication device and the target communication device in response to the determined compatibility satisfying a condition defined by a compatibility function, and in response to the characteristic satisfying a second condition defined by a link preference function.

2. The system of claim 1, further comprising a data store that maintains a set of predefined link preferences for respective transport modes of the set of communication transport modes.

3. The system of claim 2, wherein:
the query component is configured to request communication link characteristics from the network that are related to a plurality of the set of predefined link preferences for a plurality of the set of communication transport modes, and to receive respective sets of link characteristics for at least a subset of the plurality of the set of communication transport modes; and
the link compliance component is further configured to compare the respective sets of link characteristics with respective predefined link preferences of corresponding communication transport modes, and derive a preferred communication transport mode that best satisfies the second condition defined by the link preference function.

4. The system of claim 1, further comprising a charging component configured to obtain link pricing information for the call on the one of the set of communication transport modes and configured to compute a charging rate applicable for the first mobile communication device for the call.

5. The system of claim 3, wherein the charging component is further configured to obtain link pricing information for the target communication device for the call, and configured to compile a second charging rate applicable for the target communication device for the call.

6. The system of claim 1, further comprising a user interface component configured to output on a user interface of the first mobile communication device the selected one of the set of communication transport modes for the call.

7. The system of claim 6, further comprising a user override component configured to obtain an input from the user interface of the first mobile communication device and further configured to cancel or to confirm the selection of the one of the set of communication transport modes in response to the input.

8. The system of claim 7, wherein:
the device compliance component is further configured to output at the user interface a first set of characteristics of the first mobile communication device related to supporting the call and a second set of characteristics of the target mobile communication device related to supporting the call and to output an analysis of the first set of characteristics and the second set of characteristics in regard to satisfying the condition defined by the compatibility function; and
the link compliance component is further configured to output at the user interface respective characteristics of respective communication transport modes and an analysis of satisfaction of the second condition for the respective communication transport modes.

9. The system of claim 8, wherein the user interface component is configured to prioritize at the user interface respective communication transport modes in degree of satisfaction of the second condition, and further wherein the user interface component is configured to receive a transport mode selection from the user interface for establishing the call between the first mobile communication device and the target communication device.

10. A method of mobile communication, comprising:
referencing stored characteristics of a first device pertaining to compatibility with a type of mobile communication call;
receiving a selection of a target device for the mobile communication call;
referencing stored characteristics of the target device pertaining to a compatibility with the type of mobile communication call; and
outputting the type of mobile communication call as available at least in response to the stored characteristics of the first device and stored characteristics of the target device satisfying a condition of the type of mobile communication call.

11. The method of claim 10, further comprising querying a network supporting the first device for presence of the target device and availability of the target device for communication, and outputting at a user interface of the first device an availability status of the target device.

12. The method of claim 11, further comprising querying the network for one or more mobile communication transport modes to communicatively connect the first device with the target device, and outputting at a user interface of the first device a list of transport modes suitable to connect the first device with the target device.

13. The method of claim 12, further comprising outputting at the user interface respective sets of communication characteristics associated with the list of transport modes.

14. The method of claim 13, further comprising analyzing the respective sets of communication characteristics of the respective transport modes in satisfying one or more link preferences associated with the type of mobile communication call, and outputting at the user interface a result of the analyzing.

15. The method of claim 12, further comprising analyzing prevailing charging rates for the respective communication transport modes in establishing or maintaining the type of mobile communication call at least for the first device, and outputting at the user interface the prevailing charging rates for the respective communication transport modes.

16. The method of claim 10, further comprising receiving a transport mode selection at a user interface of the first device and initiating a call with the target device over the selected transport mode that is consistent with the type of the mobile communication call.

17. A user interface module for a mobile device, comprising:
a visual component configured for outputting visual information to a graphical display of a user interface of the mobile device; and
a transport management component configured for outputting to the user interface a set of network connections currently available to communicatively connect the mobile device with a target device, the user interface configured to receive input information at the user interface selecting one of the set of network connections, the transport management component further configured to initiate a call between the mobile device and the target device via the selected one of the set of network connections.

18. The user interface of claim 17, the visual component is further configured to cause the graphical display to depict a relative connection quality metric of at least a subset of the network connections.

19. The user interface of claim 17, the visual component is further configured to cause the graphical display to depict a charging rate for at least a subset of the network connections for at least one type of call between the mobile device and the target device.

20. The user interface of claim 17, further comprising a messaging optimization component configured to obtain results of an analysis pertaining to end-to-end cost or end-to-end reliability for messaging to the target device, and display the results at the graphical display, wherein the transport management component is further configured to receive an input from the user interface selecting one of a set of messaging modes for sending a message from the mobile device to the target device, the input from the user interface is configured to override a default messaging mode for the mobile device.
